(19) United States
(12) Patent Application Publication
(10) Pub. No.: US 2023/0316359 A1
(43) Pub. Date: Oct. 5, 2023

(54) INTELLIGENT SUPPLY CHAIN OPTIMIZATION

(71) Applicant: INTERNATIONAL BUSINESS MACHINES CORPORATION, Armonk, NY (US)

(72) Inventors: Rahul NAIR, Dublin (IE); Oznur ALKAN, Dublin (IE); Fearghal O'DONNCHA, Aran Islands (IE); Ambrish RAWAT, Dublin (IE)

(73) Assignee: INTERNATIONAL BUSINESS MACHINES CORPORATION, Armonk, NY (US)

(21) Appl. No.: 17/657,047

(22) Filed: Mar. 29, 2022

(51) Int. Cl. G06Q 30/06; G06Q 30/02; G06N 20/00

(52) U.S. Cl. CPC G06Q 30/0611; G06Q 30/0206; G06Q 30/0619; G06N 20/00

(57) ABSTRACT

Intelligent classification for product pedigree identification are presented. A transaction agreement request may be received from a user. A revised transaction agreement request may be generated based on one or more user profiles, a multi-party entity feedback loop, one or more constraints relating to the transaction agreement request, and a transaction agreement fulfillment requirements of the entity.

### BACKGROUND

The present invention relates in general to computing systems, and more particularly to, various embodiments for providing interactive pricing for supply chain optimization by a processor.

### SUMMARY

According to an embodiment of the present invention, a method for providing interactive pricing for supply chain optimization in a computing environment, by one or more processors, in a computing system. A transaction agreement request may be received from a user. A revised transaction agreement request may be generated based on one or more user profiles, a multi-party entity feedback loop, one or more constraints relating to the transaction agreement request, and a transaction agreement fulfillment requirements of the entity.

Thus, in addition to the foregoing exemplary method embodiments, other exemplary system and computer product embodiments are provided with these computing systems.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary computing node according to an embodiment of the present invention.

FIG. 2 is an additional block diagram depicting an exemplary cloud computing environment according to an embodiment of the present invention.

FIG. 3 is an additional block diagram depicting abstraction model layers according to an embodiment of the present invention.

FIG. 4 is a block flow diagram depicting an exemplary system for intelligent classification for providing interactive pricing for supply chain optimization by a processor, again in which aspects of the present invention may be realized.

FIG. 5 is an additional block diagram depicting an exemplary operations for providing interactive pricing for supply chain optimization in which aspects of the present invention may be realized.

FIG. 6 is an additional block diagram depicting an exemplary operations for providing interactive pricing for supply chain optimization in which aspects of the present invention may be realized.

FIG. 7 is an additional block diagram depicting an exemplary operations for reinforcement learning for providing interactive pricing for supply chain optimization in which aspects of the present invention may be realized.

FIG. 8 is a flowchart diagram depicting an additional exemplary method for providing interactive pricing for supply chain optimization by a processor, again in which aspects of the present invention may be realized.

### DETAILED DESCRIPTION OF THE DRAWINGS

Over the last decade, data analytics has become an important trend in many industries including retail/e-commerce, healthcare, manufacture and more. The reasons behind the increasing interest are the availability of data, variety of open-source machine learning tools and powerful computing resources. In fact, retail e-commerce sales are estimated to continue to rise globally. Within the retail/e-commerce industry, for example, vendors need to contend with high volume logistics and growing delivery costs. Current transaction operations between buyers and sellers are relatively rigid. In a basic scenario a seller makes an offer, and a potential buyer accepts or rejects the offer. In more complex settings, a seller makes a set of offers with minor variations, e.g., in delivery time, and buyer selects or rejects. In more innovative operations (e.g., participative pricing), buyers can price an item based on parameters set by sellers. In auction settings, collections of buyers (or sellers—for reverse auctions) drive prices up (or down) based on iterative mechanisms.

Additionally, current supply chain operations for pricing in the e-commerce/online-marketplace settings are becoming more challenging where suppliers incur logistics costs, i.e., systems dealing with physical goods. Thus, a need exists for providing intelligent and flexible operations that address one of the component of an offer such as, for example, the delivery cost/option. Taking the seller perspective, the present invention establishes cost-advantageous options to service demand and then pass on benefits to buyers for providing intelligent supply chain efficiencies for sellers, and benefits can be passed on to buyers through lower costs. Accordingly, the present invention provides for intelligent and interactive pricing for supply chain optimization in a computing environment, by one or more processors, in a computing system. A transaction agreement request may be received from a user. A revised transaction agreement request may be generated based on one or more user profiles, a multi-party entity feedback loop, one or more constraints relating to the transaction agreement request, and a transaction agreement fulfillment requirements of the entity.

In some implementations, various embodiments provide for monitoring the suppliers logistic supply chain and constraints. A component for quick assessment of marginal cost of servicing new order and to generate and monitor personalized user profiles is provided. The present invention may also dynamically generate one or more offers.

In other implementations, the present invention provides for an intelligent supply chain optimization system for providing interactive pricing for supply chain optimization by receiving as input one or more orders from a plurality of buyers. The intelligent supply chain optimization system processes and analyzes the input data and provides as output one or more offers/counter-offers/discounts that account for supply chain efficiencies and buyer preferences. The intelligent supply chain optimization system may assess marginal costs of servicing a specific order by querying current logistic supply chain states to determine cost-advantageous options and considers buyer information/preferences and then generate one or more offers for specific buyers. In this way, the intelligent supply chain optimization system provide users with supply chain efficiencies and is an artificial intelligent (“AI”) system that considers the relative bargaining power of both seller and customer during pricing/negotiations.

In one aspect, a database and/or a blockchain may be used for intelligent and interactive pricing for supply chain optimization. A blockchain is a distributed database that may be used to maintain a transaction agreement/transaction ledger. A transaction agreement/transaction ledger may denote an ordered set of transactions that have been validated or confirmed within a system up to a certain point in time. The transaction ledger may include a continuously-growing list of data records, where each data record may include data relating to one transaction. Further, encryption and other security measures may be used to secure the transaction ledger from tampering and revision. The blockchain may include a number of blocks (e.g., a transaction block), each block holding one or more individual transactions or data records. Further, each block may contain a timestamp and a link to a previous block. A blockchain network may be used and enabled users may be allowed to connect to the network, send new transactions to the blockchain, verify transactions, and create new blocks.

Also, as used herein, a computing system may include large scale computing called “cloud computing” in which resources may interact and/or be accessed via a communications system, such as a computer network. Resources may be software-rendered simulations and/or emulations of computing devices, storage devices, applications, and/or other computer-related devices and/or services run on one or more computing devices, such as a server. For example, a plurality of servers may communicate and/or share information that may expand and/or contract across servers depending on an amount of processing power, storage space, and/or other computing resources needed to accomplish requested tasks. The word “cloud” alludes to the cloud-shaped appearance of a diagram of interconnectivity between computing devices, computer networks, and/or other computer related devices that interact in such an arrangement.

In general, as used herein, “optimize” may refer to and/or defined as “maximize,” “minimize,” or attain one or more specific targets, objectives, goals, or intentions. Optimize may also refer to maximizing a benefit to a user (e.g., maximize a trained machine learning pipeline/model benefit). Optimize may also refer to making the most effective or functional use of a situation, opportunity, or resource.

Additionally, optimizing need not refer to a best solution or result but may refer to a solution or result that “is good enough” for a particular application, for example. In some implementations, an objective is to suggest a “best” combination of preprocessing operations (“preprocessors”) and/or machine learning models/machine learning pipelines, but there may be a variety of factors that may result in alternate suggestion of a combination of preprocessing operations (“preprocessors”) and/or machine learning models yielding better results. Herein, the term “optimize” may refer to such results based on minima (or maxima, depending on what parameters are considered in the optimization problem). In an additional aspect, the terms “optimize” and/or “optimizing” may refer to an operation performed in order to achieve an improved result such as reduced execution costs or increased resource utilization, whether or not the optimum result is actually achieved. Similarly, the term “optimize” may refer to a component for performing such an improvement operation, and the term “optimized” may be used to describe the result of such an improvement operation.

It should be noted as described herein, the term “intelligent” (or “intelligence”) may be relating to, being, or involving conscious intellectual activity such as, for example, thinking, reasoning, or remembering, that may be performed using a machine learning. In an additional aspect, intelligent or “intelligence” may be the mental process of knowing, including aspects such as awareness, perception, reasoning and judgment. A machine learning system may use artificial reasoning to interpret data from one or more data sources (e.g., sensor-based devices or other computing systems) and learn topics, concepts, and/or processes that may be determined and/or derived by machine learning.

In an additional aspect, intelligent or “intelligence” may refer to a mental action or process of acquiring knowledge and understanding through thought, experience, and one or more senses using machine learning (which may include using sensor-based devices or other computing systems that include audio or video devices). Intelligent or “intelligence” may also refer to identifying patterns of behavior, leading to a “learning” of one or more events, operations, or processes. Thus, the intelligent or artificial intelligence “AI” model may, over time, develop semantic labels to apply to observed behavior and use a knowledge domain or ontology to store the learned observed behavior. In one embodiment, the system provides for progressive levels of complexity in what may be learned from the one or more events, operations, or processes.

In additional aspect, the term intelligent or “intelligence” may refer to an intelligent system. The intelligent system may be a specialized computer system, or set of computer systems, configured with hardware and/or software logic (in combination with hardware logic upon which the software executes) to emulate human cognitive functions. These intelligent systems apply human-like characteristics to convey and manipulate ideas which, when combined with the inherent strengths of digital computing, can solve problems with a high degree of accuracy (e.g., within a defined percentage range or above an accuracy threshold) and resilience on a large scale. An intelligent system may perform one or more computer-implemented cognitive operations that approximate a human thought process while enabling a user or a computing system to interact in a more natural manner. An intelligent system may comprise artificial intelligence logic, such as natural language processing (NLP) based logic, for example, and machine learning logic, which may be provided as specialized hardware, software executed on hardware, or any combination of specialized hardware and software executed on hardware. The logic of the cognitive system may implement the cognitive operation(s), examples of which include, but are not limited to, question answering, identification of related concepts within different portions of content in a corpus, and intelligent search algorithms, such as Internet web page searches.

In general, such intelligent systems are able to perform the following functions: 1) Navigate the complexities of human language and understanding; 2) Ingest and process vast amounts of structured and unstructured data; 3) Generate and evaluate hypotheses; 4) Weigh and evaluate responses that are based only on relevant evidence; 5) Provide situation-specific advice, insights, estimations, determinations, evaluations, calculations, and guidance; 6) Improve knowledge and learn with each iteration and interaction through machine learning processes; 7) Enable decision making at the point of impact (contextual guidance); 8) Scale in proportion to a task, process, or operation; 9) Extend and magnify human expertise and cognition; 10) Identify resonating, human-like attributes and traits from natural language; 11) Deduce various language specific or agnostic attributes from natural language; 12) Memorize and recall relevant data points (images, text, voice) (e.g., a high degree of relevant recollection from data points (images, text, voice) (memorization and recall)); and/or 13) Predict and sense with situational awareness operations that mimic human cognition based on experiences.

It should be noted that one or more computations or calculations may be performed using various mathematical operations or functions that may involve one or more mathematical operations (e.g., solving differential equations or partial differential equations analytically or computationally, using addition, subtraction, division, multiplication, standard deviations, means, averages, percentages, statistical modeling using statistical distributions, by finding minimums, maximums or similar thresholds for combined variables, etc.).

Other examples of various aspects of the illustrated embodiments, and corresponding benefits, will be described further herein.

It is understood in advance that although this disclosure includes a detailed description on cloud computing, implementation of the teachings recited herein are not limited to a cloud computing environment and/or computing systems associated with one or more vehicles. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

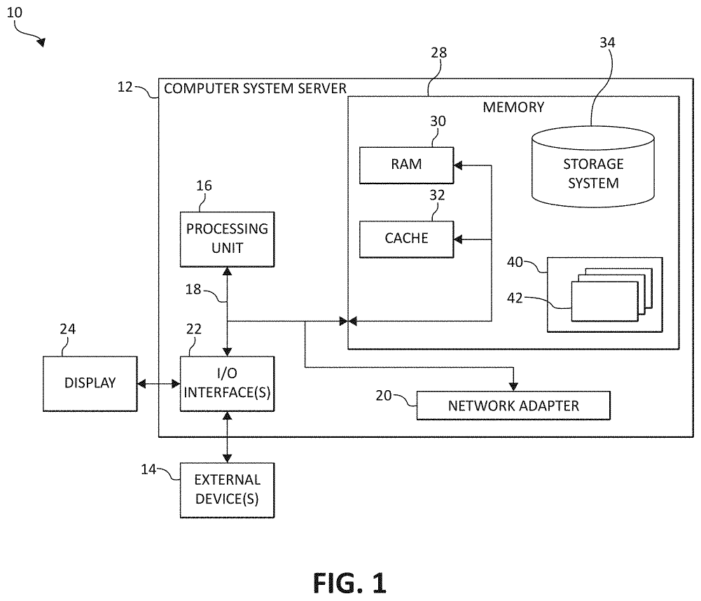

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32.

Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

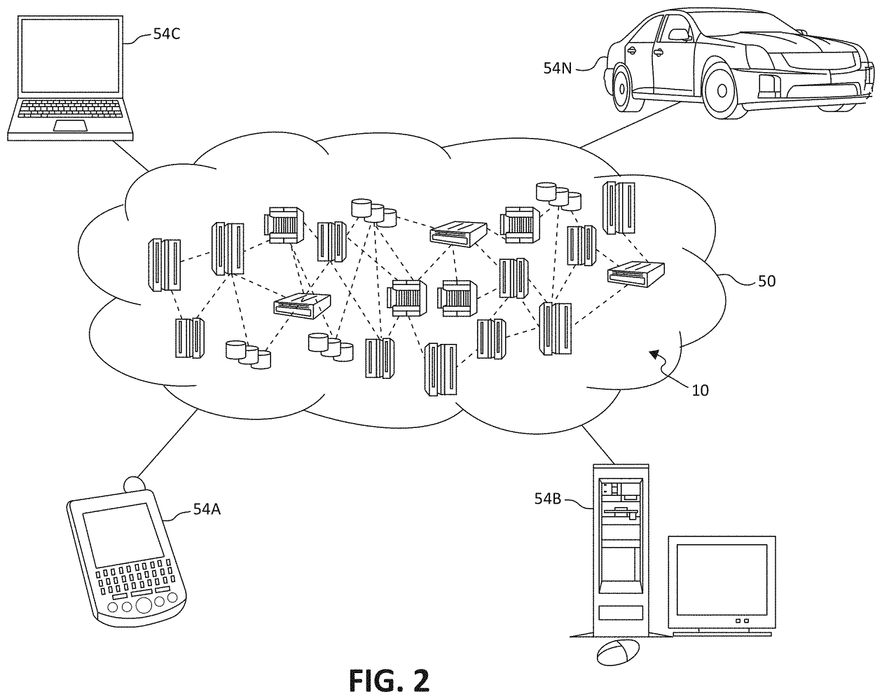

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

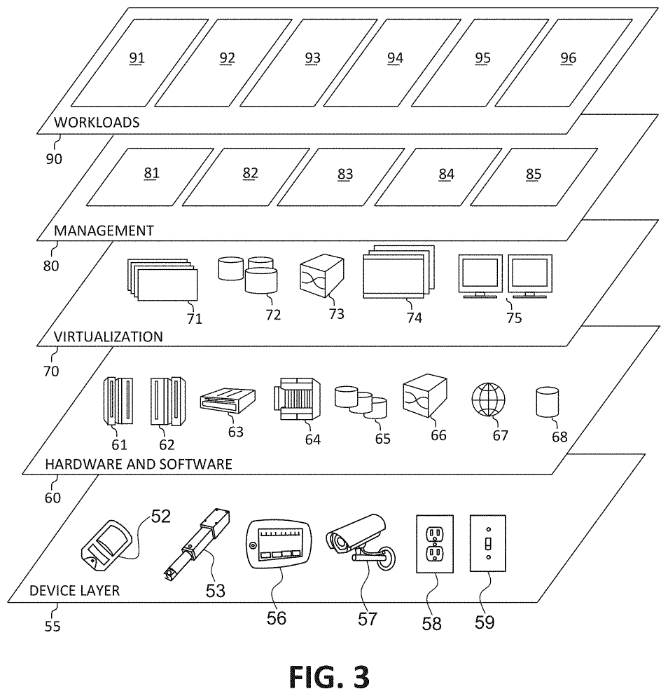

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for providing interactive pricing for supply chain optimization. In addition, workloads and functions 96 for providing interactive pricing for supply chain optimization may include such operations as data analytics, data analysis, and as will be further described, notification functionality. One of ordinary skill in the art will appreciate that the workloads and functions 96 for providing interactive pricing for supply chain optimization may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

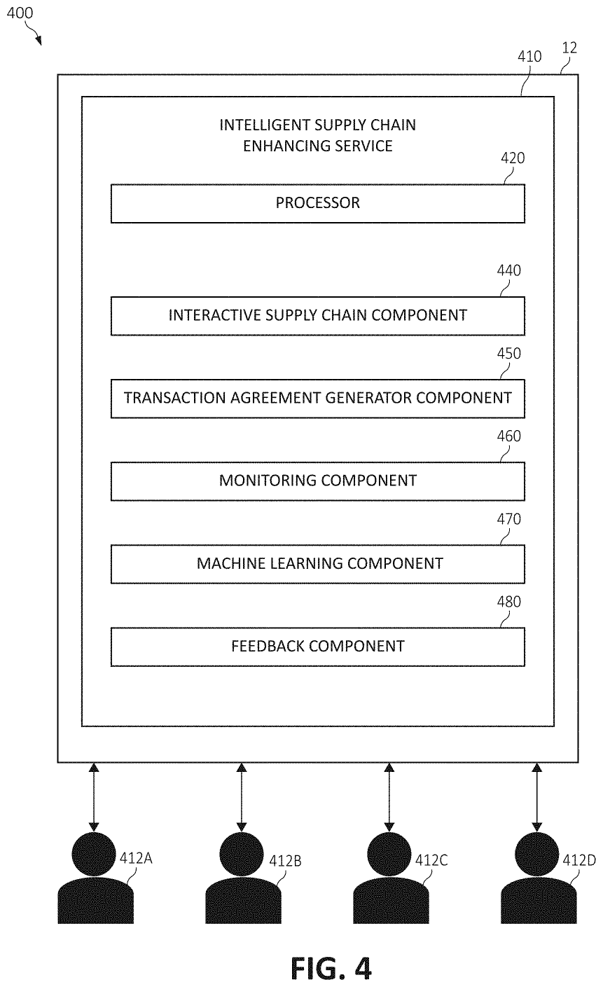

Turning now to FIG. 4, a block diagram depicting exemplary functional components of system 400 (e.g., an intelligent supply chain enhancing system 400) for providing interactive pricing for supply chain optimization in a computing environment according to various mechanisms of the illustrated embodiments is shown. In one aspect, one or more of the components, modules, services, applications, and/or functions described in FIGS. 1-3 may be used in FIG. 4. As will be seen, many of the functional blocks may also be considered “modules” or “components” of functionality, in the same descriptive sense as has been previously described in FIGS. 1-3.

In one aspect, the computer system/server 12 may provide virtualized computing services (i.e., virtualized computing, virtualized storage, virtualized networking, etc.) to the intelligent conversational agent management and interaction service 402 and the conversation agent 404. More specifically, the computer system/server 12 may provide virtualized computing, virtualized storage, virtualized networking and other virtualized services that are executing on a hardware substrate.

An intelligent supply chain enhancing service 410 is shown, incorporating processing unit 420 (“processor”) to perform various computational, data processing and other functionality in accordance with various aspects of the present invention. In one aspect, the processor 420 and memory 430 may be internal and/or external to the intelligent supply chain enhancing service 410, and internal and/or external to the computing system/server 12. The intelligent supply chain enhancing service 410 may be included and/or external to the computer system/server 12, as described in FIG. 1. The processing unit 420 may be in communication with the memory 430. The intelligent supply chain enhancing service 410 may include an interactive supply chain component 440, a transaction agreement generator component 450, a monitoring component 460, and a machine learning component 470, and a feedback component 480.

In one aspect, the system 400 may provide virtualized computing services (i.e., virtualized computing, virtualized storage, virtualized networking, etc.). More specifically, the system 400 may provide virtualized computing, virtualized storage, virtualized networking and other virtualized services that are executing on a hardware substrate.

In some implementations, the intelligent supply chain enhancing service 410 is in communication with one or more users 412A-D (e.g., users, administrators, vendors, business entities, supply chain logistic service providers, etc.)

It should be noted that the one or more users 412A-D may be considered as providers (e.g., sellers or suppliers of goods/services) and recipients (e.g., buyers of goods/services) in an multi group feedback loop and interactive supply chain optimizer via the intelligent supply chain enhancing service 410. For example, those of the one or more users 412A-D are providers (e.g., sellers or suppliers) may interactively obtain preferences of those of the one or more users 412A-D considered as recipients (e.g., buyer) and provides new options in order to optimize the supply chain over one or more operational steps/operations.

The intelligent supply chain enhancing service 410 for providing interactive pricing for supply chain optimization may activate and use the interactive supply chain component 440, the transaction agreement generator component 450, the monitoring component 460, the machine learning component 470, and the feedback component 480 to receive a transaction agreement request from a user (e.g., one or more of the one or more users 412A-D) and generate a revised transaction agreement request based on one or more user profiles (e.g., one or more of the one or more users 412A-D), a multi-party entity feedback loop (e.g., one or more of the one or more users 412A-D), one or more constraints relating to the transaction agreement request, and a transaction agreement fulfillment requirements of the entity (e.g., one or more of the one or more users 412A-D).

The intelligent supply chain enhancing service 410 for providing interactive pricing for supply chain optimization may activate and use the interactive supply chain component 440, the transaction agreement generator component 450, the monitoring component 460, the machine learning component 470, and the feedback component 480 to query a supply chain state to identify a cost for servicing the transaction agreement request.

The intelligent supply chain enhancing service 410, for providing interactive pricing for supply chain optimization, may activate and use the interactive supply chain component 440, the transaction agreement generator component 450, the monitoring component 460, the machine learning component 470, and the feedback component 480 to generate and monitor the one or more user profiles.

The intelligent supply chain enhancing service 410, for providing interactive pricing for supply chain optimization, may activate and use the interactive supply chain component 440, the transaction agreement generator component 450, the monitoring component 460, the machine learning component 470, and the feedback component 480 to identify the one or more marginal transaction agreement fulfillment requirements for performing the transaction agreement request.

The intelligent supply chain enhancing service 410, for providing interactive pricing for supply chain optimization, may activate and use the interactive supply chain component 440, the transaction agreement generator component 450, the monitoring component 460, the machine learning component 470, and the feedback component 480 to identify one or more transaction agreement fulfillment options for performing the transaction agreement request the entity; and select a transaction agreement fulfillment option for performing the transaction agreement request by the entity having a least amount of constraints and transaction agreement fulfillment requirements for fulfilling the transaction agreement request.

The intelligent supply chain enhancing service 410, for providing interactive pricing for supply chain optimization, may activate and use the interactive supply chain component 440, the transaction agreement generator component 450, the monitoring component 460, the machine learning component 470, and the feedback component 480 to dynamically negotiate the revised transaction agreement request between a provider and the user using a machine learning operation, wherein the provider and the user are included in the multi-party entity feedback loop.

The intelligent supply chain enhancing service 410, for providing interactive pricing for supply chain optimization, may activate and use the interactive supply chain component 440, the transaction agreement generator component 450, the monitoring component 460, the machine learning component 470, and the feedback component 480 to implement a machine learning component to learn a supply chain state, one or more acceptance or rejections of historical transaction agreements and revised transaction agreement requests, behaviors of the user, and one or more policies based on a value function.

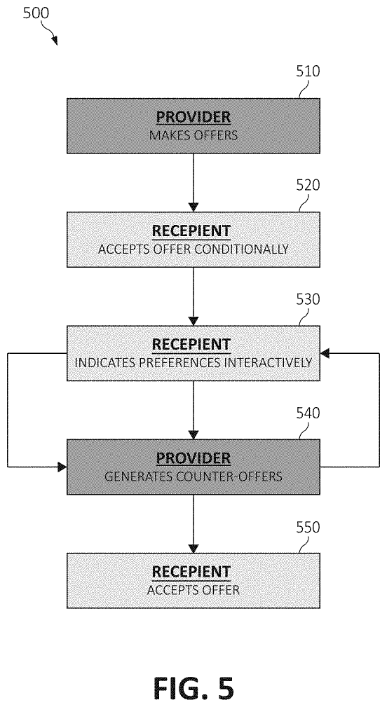

For further explanation, FIG. 5 is an additional block diagram depicting an interactive environment 500 for providing interactive pricing for supply chain optimization. In one aspect, one or more of the components, modules, services, applications, and/or functions described in FIGS. 1-4 may be used in FIG. 5. As will be seen, many of the functional blocks may also be considered “modules” of functionality, in the same descriptive sense as has been previously described in FIGS. 1-4. In some implementations, the intelligent supply chain enhancing service 410 provides the multi-party interactive environment 500.

It should be noted that the interactive environment 500 enables communication both providers and recipients (e.g., buyers) in real time simultaneously. For example, each recipient, upon completing the online shopping in the multiple buyer interactive platform, starts an interaction with the interactive environment 500 (e.g., which may be through a chatbot as the interface of the invention) to pick a time slot for delivery.

The interactive environment 500 (e.g., using the intelligent supply chain enhancing service 410 of FIG. 4) enables recipients to negotiate over various conditions, constraints, and parameters such as, for example, available time slots and costs of the shipment. The interactive environment 500 (e.g., using the intelligent supply chain enhancing service 410 of FIG. 4) searches and determines other shipment plans in order, and the current negotiations to offer a slot and price. For example, the interactive environment 500 (e.g., using the intelligent supply chain enhancing service 410 of FIG. 4) determines if there are other providers that are based in the same area with an active user, seller can lower the shipment cost for a slot that is close to the slots agreed by those providers. The provider can suggest counter offers. e.g., an offer with a lower cost. The interactive environment 500 (e.g., using the intelligent supply chain enhancing service 410 of FIG. 4) may suggest alternative price-slot pairs (e.g., the intelligent supply chain enhancing service 410 acts as agent representing recipient's perspective). The interaction with a recipient continues until the recipient accepts a slot and price or the time limit for accepting an offer is exceeded.

For example, in operation, starting at block 510, a single provider (e.g., a vendor or seller) provides an offer to a multiple buyer interactive platform (e.g., a single vendor ecommerce website/marketplace). In some implementations, the single provider may deliver one or more products to one or more buyers upon agreeing on a price/time-slot for the shipment. In block 520, a recipient may accept and/or conditionally accept the offer. In block 530, the recipient may interactively indicate (with the provider in a multi-loop feedback environment) one or more preferences relating to the offer.

In block 540, the provider (e.g., using the intelligent supply chain enhancing service 410 of FIG. 4) may generate one or more counter-offers. The recipient may (e.g., using the intelligent supply chain enhancing service 410 of FIG. 4) accept the counter-offer(s), as in block 550.

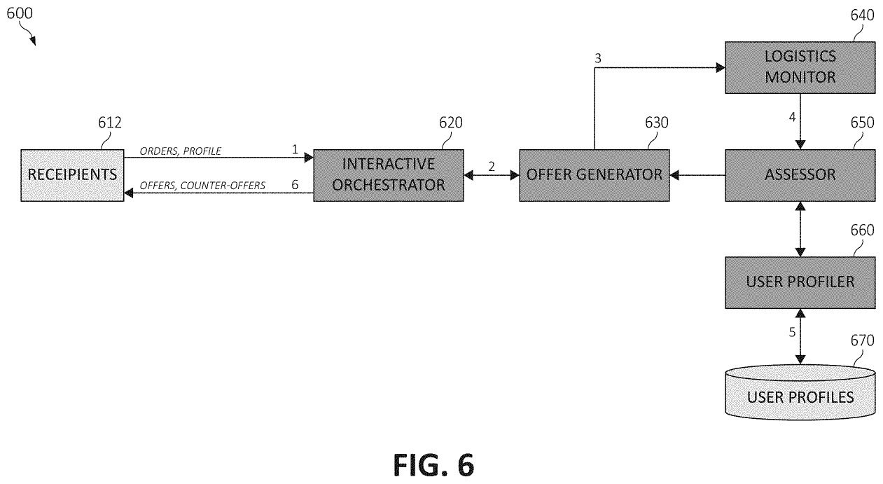

For further explanation, FIG. 6 is an additional block diagram depicting an interactive environment 600 for providing interactive pricing for supply chain optimization. In one aspect, one or more of the components, modules, services, applications, and/or functions described in FIGS. 1-5 may be used in FIG. 6. As will be seen, many of the functional blocks may also be considered “modules” of functionality, in the same descriptive sense as has been previously described in FIGS. 1-5. In some implementations, the intelligent supply chain enhancing service 410 provides the multi-party interactive environment 600.

In operation, consider the following operational steps of the interactive environment 600 for providing interactive pricing for supply chain optimization.

In step 1), one or more recipients (e.g., buyers) enter order details (which may include a user profile) through an interactive orchestrator 620. In step 2) the interactive orchestrator 620 queries a generation component 630 (e.g., offer generator) to see if any cost/advantageous alternatives exist by step 3) of valuating a current logistics state in a logistics component 640 and, in step 4) assessing a marginal cost/revenue of fulfilling this recipient's (e.g., buyers) demand using the user profile information in the user profiler component 660. In steps 5 and 6) one or more updated time-sensitive offers and/or counteroffers may be provided and offered to the one or more recipients (e.g., buyers).

It should be noted that the interactive orchestrator 620 provides interaction with the one or more recipients (e.g., buyers) and one or more providers (e.g., sellers or supplies) and the interaction can take place through an interactive UI or a chatbot where the interactive orchestrator 620 can display an offers and counter offers and enables the user to place a counter offer, accept/reject the offers suggested by the interactive environment 600 (e.g., the intelligent supply chain enhancing service 410). For example, in some implementation, the user interface layer can be achieved through using an AI assistant/machine learning component to build a conversational interaction environment (e.g., a chatbot) to enable users and the seller to communicate to achieve the functionalities as described herein).

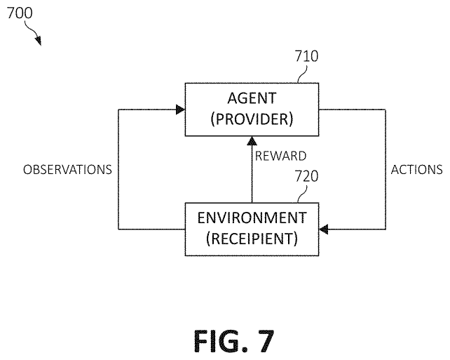

For further explanation, FIG. 7 is an additional block diagram depicting an exemplary operations for reinforcement learning for providing interactive pricing for supply chain optimization in which aspects of the present invention may be realized. In one aspect, one or more of the components, modules, services, applications, and/or functions described in FIGS. 1-6 may be used in FIG. 7. As will be seen, many of the functional blocks may also be considered “modules” of functionality, in the same descriptive sense as has been previously described in FIGS. 1-6. In some implementations, the intelligent supply chain enhancing service 410 provides the multi-party interactive environment 700 with an agent 710 (e.g., a state agent or provider/seller) and a recipient 720 (e.g., an environment of the recipient 720) that provide, generate, and monitor observations, rewards, and actions between the agent 710 (e.g., a state agent or provider/seller) and the recipient 720.

In some implementations, reinforcement learning is provided interactive pricing for supply chain optimization. For example, a machine learning operation may be executed for reinforcement learning problem where the agent information (Sₜ) needed to decide/determine one or more actions may includes information on current logistics, cost estimators, and query functions to determine marginal costs. An action may include, for example, one or more offer decisions, including accept/reject and generation of new offers (Aₜ). The observations may be a set of orders and associated parameters generated by the collection of buyers in the environment (Oₜ) that can include buyer profile information. A reward may be revenue/cost outcomes from buyer decisions that are realized (Rₜ).

The intelligent supply chain enhancing system (e.g., the intelligent supply chain enhancing service 410 employing and using the agent 710 (e.g., a state agent or provider/seller) and the recipient 720) may determine/decide on a specific policy (how a seller maps logistic states to actions) based on a value function (how good is each (state/action), i.e., prediction of future total reward/award. The intelligent supply chain enhancing system (e.g., the intelligent supply chain enhancing service 410 employing and using the agent 710 (e.g., a state agent or provider/seller) and the recipient 720) may optionally employ a model (e.g., a machine learning model) where the model is from the perspective of the agent 710 (e.g., a state agent or provider/seller) or the agent 710 (e.g., a state agent or provider/seller) view of a set of the recipient 720 (e.g., buyers) (e.g., dynamics and rewards/awards such as, a reward of a thing or service of value).

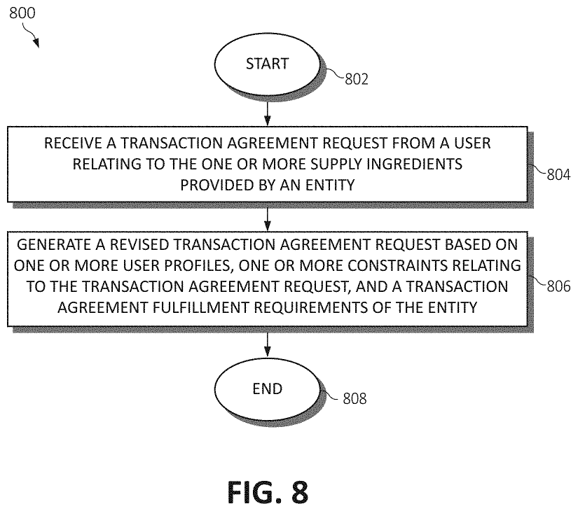

Turning now to FIG. 8, a method 800 for providing intelligent supply chain optimization by a processor is depicted, in which various aspects of the illustrated embodiments may be implemented. The functionality 800 may be implemented as a method executed as instructions on a machine, where the instructions are included on at least one computer readable medium or one non-transitory machine-readable storage medium. The functionality 800 may start in block 802.

A transaction agreement request may be received from a user, as in block 804. A revised transaction agreement request may be generated based on one or more user profiles, a multi-party entity feedback loop, one or more constraints relating to the transaction agreement request, and a transaction agreement fulfillment requirements of the entity, as in block 806. The functionality 800 may end, as in block 808.

In one aspect, in conjunction with and/or as part of at least one block of FIG. 8, the operations of method 800 may include each of the following. The operations of method 800 may query a supply chain state to identify a cost for servicing the transaction agreement request.

The operations of method 800 may generate and monitor the one or more user profiles. The operations of method 800 may identify the one or more marginal transaction agreement fulfillment requirements for performing the transaction agreement request.

The operations of method 800 may identify one or more transaction agreement fulfillment options for performing the transaction agreement request the entity; and select a transaction agreement fulfillment option for performing the transaction agreement request by the entity having a least amount of constraints and transaction agreement fulfillment requirements for fulfilling the transaction agreement request.

The operations of method 800 may the revised transaction agreement request between a provider and the user using a machine learning operation, wherein the provider and the user are included in the multi-party entity feedback loop. The operations of method 800 may implement a machine learning component to learn a supply chain state, one or more acceptance or rejections of historical transaction agreements and revised transaction agreement requests, behaviors of the user, and one or more policies based on a value function.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method for providing intelligent supply chain optimization by a processor, comprising:
receiving a transaction agreement request from a user; and
generating a revised transaction agreement request based on one or more user profiles, a multi-party entity feedback loop, one or more constraints relating to the transaction agreement request, and a transaction agreement fulfillment requirements of the entity.

2. The method of claim 1, further including querying a supply chain state to identify a cost for servicing the transaction agreement request.

3. The method of claim 1, further including generating and monitoring the one or more user profiles.

4. The method of claim 1, further including identifying the one or more marginal transaction agreement fulfillment requirements for performing the transaction agreement request.

5. The method of claim 1, further including:
identifying one or more transaction agreement fulfillment options for performing the transaction agreement request the entity; and
selecting a transaction agreement fulfillment option for performing the transaction agreement request by the entity having a least amount of constraints and transaction agreement fulfillment requirements for fulfilling the transaction agreement request.

6. The method of claim 1, further including dynamically negotiating the revised transaction agreement request between a provider and the user using a machine learning operation, wherein the provider and the user are included in the multi-party entity feedback loop.

7. The method of claim 1, further including implementing a machine learning component to learn and collect feedback data relating to a supply chain state, one or more acceptance or rejections of historical transaction agreements and revised transaction agreement requests, behaviors of the user, and one or more policies based on a value function.

8. A system for providing intelligent supply chain optimization, comprising:
one or more computers with executable instructions that when executed cause the system to:
receive a transaction agreement request from a user; and
generate a revised transaction agreement request based on one or more user profiles, a multi-party entity feedback loop, one or more constraints relating to the transaction agreement request, and a transaction agreement fulfillment requirements of the entity.

9. The system of claim 8, wherein the executable instructions when executed cause the system to query a supply chain state to identify a cost for servicing the transaction agreement request.

10. The system of claim 8, wherein the executable instructions when executed cause the system to generate and monitor the one or more user profiles.

11. The system of claim 8, wherein the executable instructions when executed cause the system to identify the one or more marginal transaction agreement fulfillment requirements for performing the transaction agreement request.

12. The system of claim 8, wherein the executable instructions when executed cause the system to:
identify one or more transaction agreement fulfillment options for performing the transaction agreement request the entity; and
select a transaction agreement fulfillment option for performing the transaction agreement request by the entity having a least amount of constraints and transaction agreement fulfillment requirements for fulfilling the transaction agreement request.

13. The system of claim 8, wherein the executable instructions when executed cause the system to dynamically negotiate the revised transaction agreement request between a provider and the user using a machine learning operation, wherein the provider and the user are included in the multi-party entity feedback loop.

14. The system of claim 8, wherein the executable instructions when executed cause the system to implement a machine learning component to learn a supply chain state, one or more acceptance or rejections of historical transaction agreements and revised transaction agreement requests, behaviors of the user, and one or more policies based on a value function.

15. A computer program product for providing intelligent supply chain optimization in a computing environment, the computer program product comprising:
one or more computer readable storage media, and program instructions collectively stored on the one or more computer readable storage media, the program instruction comprising:
program instructions to receive a transaction agreement request from a user; and
generate a revised transaction agreement request based on one or more user profiles, a multi-party entity feedback loop, one or more constraints relating to the transaction agreement request, and a transaction agreement fulfillment requirements of the entity.

16. The computer program product of claim 15, further including program instructions to query a supply chain state to identify a cost for servicing the transaction agreement request.

17. The computer program product of claim 15, further including program instructions to generate and monitor the one or more user profiles.

18. The computer program product of claim 15, further including program instructions to identify the one or more marginal transaction agreement fulfillment requirements for performing the transaction agreement request.

19. The computer program product of claim 15, further including program instructions to:
identify one or more transaction agreement fulfillment options for performing the transaction agreement request; and
select a transaction agreement fulfillment option for performing the transaction agreement request by the entity having a least amount of constraints and transaction agreement fulfillment requirements for fulfilling the transaction agreement request; and
dynamically negotiate the revised transaction agreement request between a provider and the user using a machine learning operation, wherein the provider and the user are included in the multi-party entity feedback loop.

20. The computer program product of claim 15, further including program instructions to implement a machine learning component to learn a supply chain state, one or more acceptance or rejections of historical transaction agreements and revised transaction agreement requests, behaviors of the user, and one or more policies based on a value function.
